(19) United States
(12) Patent Application Publication
(10) Pub. No.: US 2026/0252062 A1
(43) Pub. Date: Aug. 27, 2026

(54) ANALYZING INPUT DATA OF A RESPECTIVE DEVICE AND/OR CONTROLLING THE RESPECTIVE DEVICE METHOD AND SYSTEM

(71) Applicant: Siemens Aktiengesellschaft, München (DE)

(72) Inventors: Marcel Rothering, Nürnberg (DE); Johannes Nehrkorn, Möhrendorf (DE); Tian Eu Lau, Erlangen (DE); Rana Azeem Khan, Nürnberg (DE); Adam Alpire, Erlangen (DE); Johann Bruckner, Nürnberg (DE)

(21) Appl. No.: 18/871,046

(22) PCT Filed: May 12, 2023
(86) PCT No.: PCT/EP2023/062811

§ 371 Date: Dec. 2, 2024

(30) Foreign Application Priority Data
Jun. 2, 2022 (EP) 22176954.0

(51) Int. Cl. G05B 19/418; G05B 23/02

(52) U.S. Cl. CPC G05B 19/41875; G05B 23/027

(57) ABSTRACT

For improved analysis and/or control of a device, a method includes providing input data from the device. A trained function is provided for processing the input data to generate output data. The output data is suitable for analyzing and/or controlling the device. The method includes determining if the input data is suitable for processing with the trained function and processing the input data with the trained function to generate the output data only if the input data is determined to be suitable for processing with the trained function. A suitability criterion is provided for the input data. The input data is determined to be not suitable for processing with the trained function if the input data does not comply with the suitability criterion, and/or the input data is determined to be suitable for processing with the trained function if the input data complies with the suitability criterion.

This application is the National Stage of International Application No. PCT/EP2023/062811, filed May 12, 2023, which claims the benefit of European Patent Application No. EP 22176954.0, filed Jun. 2, 2022. The entire contents of these documents are hereby incorporated herein by reference.

### TECHNICAL FIELD

The present disclosure is directed, in general, to automation or software management systems, and, in particular, systems for analyzing input data of a respective device and/or controlling the respective device (collectively referred to herein as product systems).

### BACKGROUND

Recently, trained functions, such as functions derived using artificial intelligence, machine learning models, or the like are increasingly used to analyze input data of a respective device and/or to control the respective device. Currently, there exist product systems and solutions that support analyzing input data of a respective device and/or controlling the respective device using a trained function. Such product systems may benefit from improvements.

### SUMMARY AND DESCRIPTION

The present embodiments generally relate to analyzing input data of a respective device and/or controlling the respective device using a trained function.

Variously disclosed embodiments include methods and computer systems that may be used to facilitate analyzing input data of a respective device and/or controlling the respective device.

According to a first aspect of the present embodiments, a computer-implemented method of analyzing input data of a respective device and/or controlling the respective device may include providing input data from the respective device; providing a trained function for processing the input data to generate output data, the output data being suitable for analyzing and/or controlling the respective device; determining if the input data is suitable for processing with the trained function; processing the input data with the trained function to generate the output data only if the input data is determined to be suitable for processing with the trained function; providing at least one suitability criterion for the input data, the respective suitability criterion including an input data image pixel size, an input data image brightness, an input data image luminance, an input data image contrast, an input data image saturation, an input data image size, an input data image color, an input data image hue, an input data image sharpness, an input data image chromaticity, an input data image metadata, or any combination thereof; determining the input data to be not suitable for processing with the trained function if the input data does not comply with the respective suitability criterion and/or determining the input data to be suitable for processing with the trained function if the input data complies with the respective suitability criterion.

According to a second aspect of the present embodiments, a computer system including at least one processor may be arranged and configured to execute the acts of the computer-implemented method according to the first aspect of the present embodiments.

According to a third aspect of the present embodiments, a computer program product may include computer program code that, when executed by the computer system according to the second aspect of the present embodiments, causes the computer system to carry out the method according to the first aspect of the present embodiments.

According to a fourth aspect of the present embodiments, a computer-readable medium may include the computer program product according to the third aspect of the present embodiments. By way of example, the described computer-readable medium may be non-transitory and may further be a software component on a storage device.

### BRIEF DESCRIPTION OF THE DRAWINGS

FIG. 1 illustrates a functional block diagram of an example system that facilitates analyzing input data of a respective device and/or controlling the respective device, in a product system, respectively.

FIG. 2 illustrates a flow diagram of another methodology of analyzing input data of a respective device.

FIGS. 3-5 illustrate a functional block diagram of a further example system that facilitates analyzing input data of a respective device and/or controlling the respective device, in a product system, respectively.

FIG. 6 illustrates an example message in the context of facilitated analysis of input data of a respective device and/or control of the respective device, in a product system.

FIGS. 7 and 8 illustrate a flow diagram of an example methodology that facilitates analyzing input data of a respective device and/or controlling the respective device, in a product system, respectively.

FIG. 9 illustrates a block diagram of a data processing system in which an embodiment may be implemented.

### DETAILED DESCRIPTION

Various technologies that pertain to systems and methods for analyzing input data of a respective device and/or controlling the respective device in a product system will now be described with reference to the drawings, where like reference numerals represent like elements throughout. Those skilled in the art will understand that the principles of the present disclosure may be implemented in any suitably arranged apparatus. Functionality that is described as being carried out by certain system elements may be performed by multiple elements. Similarly, for example, an element may be configured to perform functionality that is described as being carried out by multiple elements.

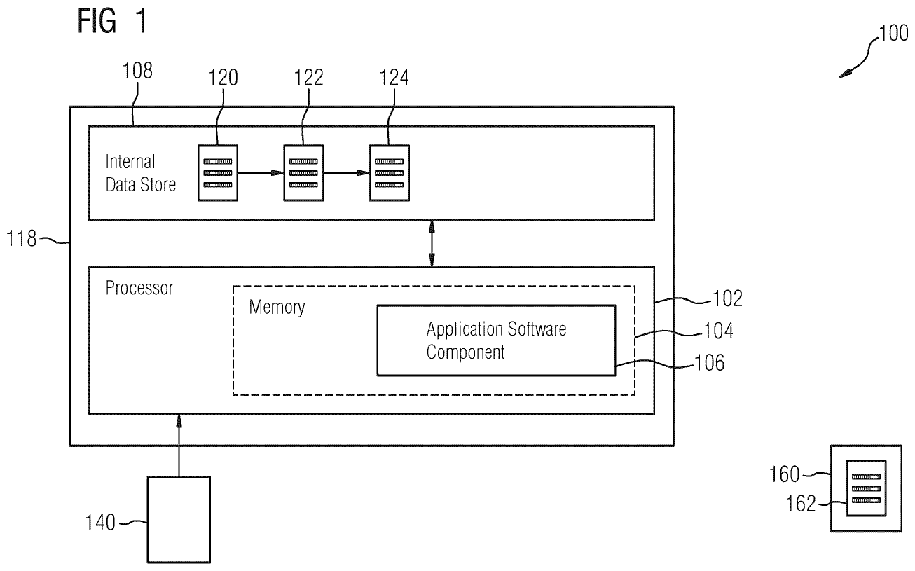

With reference to FIG. 1, a functional block diagram of an example data processing system 100 that facilitates analyzing input data 120 of a respective device 140 and/or controlling the respective device 140 is illustrated. The data processing system 100 may, in some examples, include a computation device 118 or, more generally, a computer system allowing the analysis of input data 120 of a respective device 140 and/or the control of the respective device 140 by providing corresponding functionalities (e.g., to a user). The computation device 118 may include at least one processor 102 that is configured to execute at least one application software component 106 from a memory 104 accessed by the processor 102. The application software component 106 may be configured (e.g., programmed) to cause the processor 102 to carry out various acts and functions described herein. For example, the described application software component 106 may include and/or correspond to one or more components of an analysis and/or a control software application that may be configured to generate and store output data 124 in a data store 108 such as a memory or a database.

By way of example, the processing system 100 or optionally the computation device 118 may include at least one display device 112 (e.g., a display screen) and optionally at least one input device 110. The described processor 102 may be configured to generate a graphical user interface (GUI) 114 through the display device 112. Such a GUI may include GUI elements such as buttons, links, search boxes, lists, text boxes, images, and/or scroll bars usable by a user to provide inputs through the input device 110 that may support or cause analyzing input data 120 of the respective device 140 and/or controlling the respective device 140.

In some examples, the data processing system 100 may be used in the context of the production of printed circuit boards (PCBs) that are typically the main parts of many automation products. Such automation products may control machine tools, entire production lines, production processes, and more. Manufacturing of PCBs often happens in highly automated production lines that include quality testing on multiple steps. Test equipment may be highly standardized, and accordingly, tests may be performed at similar production steps across multiple production lines and factories. To provide high quality of PCBs and subsequently products, test equipment may be tuned to be very sensitive to potential errors of PCBs. To reduce the number of pseudo errors or false calls of the test equipment (e.g., “false positives”), trained functions 122, such as machine learning models (ML models), may reevaluate test equipment data when the test equipment reports failures. Trained functions 122 may, in some PCB production examples, reduce the pseudo error rate by up to 50% (e.g., based on training of historical data), while keeping the slip rate (e.g., “false negatives”) low. Any remaining PCB boards may need to be checked manually and potentially reworked.

For example, the results of the trained functions 122 or the ML model may be an integral part of the production. Prediction results may be produced synchronously with the production tact (e.g., every time the test equipment reports a failure, the trained functions 122 may need to provide a prediction result reliably with the smallest delay possible). To achieve this, trained functions 122 may be deployed on industrial PCs (IPCs) that may be physically and network-wise close to the test equipment to reduce any potential delay. Hereby, the computation device 118 may correspond to the industrial PC, and the device 140 may correspond to the PCB production line or the test equipment that may be comprised by the PCB production line. The computation device 118 (e.g., the industrial PC) may be resource-constraint in terms of CPU power, memory, storage, and chosen in a cost-optimizing way to allow them to execute the trained function 122 or the ML model in the targeted time.

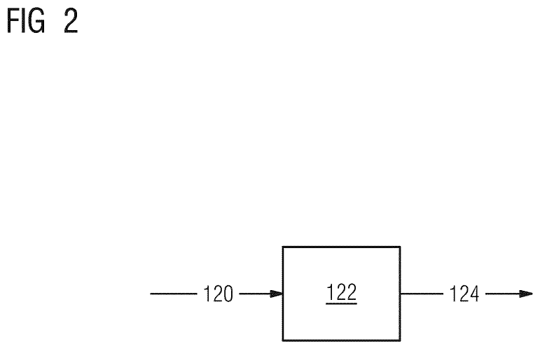

A typical data flow for a ML inference pipeline is shown in FIG. 2. An ML model or trained function 122 receives tabular input data 120 (e.g., consisting of a unique identifier, measurements that are used within the model (“features”) and additional metadata not used for prediction). The ML model or trained function 122 consumes the input data 120 and performs a classification between pseudo errors and real errors, whereby the classification is the output data 124 of the trained function 122. A pseudo error result may overwrite the result of the test equipment, and the PCB board is further processed as usual. Confirmation of a real error results in diverting the PCB board in the production flow to a manual rework station.

In some examples, some factors may make it impossible to make a prediction (e.g., processing the input data 120 with the trained function 122 to generate reliable and trustworthy output data 124). Such factors may include missing measurements (e.g., “features”). For example, upstream adjustments to the test equipment may result in missing features within the input data (e.g., instead of 10 features, the ML model only receives 9 features). Further, such factors may include changed data types of features. For example, upstream adjustments to the test equipment or connectors to the IPC may result in changes of the data types of the input data 120 (e.g., a decimal separator may change from ‘.’ to ‘,’). In further examples, some factors may reduce the reliability of the ML model prediction (e.g., the output data 124 of the trained function 122). Such factors may include values outside known boundaries. By way of example, different components on PCB boards may result in measurements of the test equipment outside the known boundaries of the initial training data set of the ML model or trained function 122. The behavior of the ML model or trained function 122 with respect to this data may be unknown. Further, such factors may include a changed precision level. For example, upstream adjustments may lead to a change in the number of significant digits for the model input features (e.g., for feature electric current, the feature value 1.26 mA may change to 1.3 mA; there is a decrease in precision, whereby the behavior of the ML model or trained function 122 with respect to these changes may be unknown).

In light of the above explanations, it should be appreciated that it may be very difficult to derive reliable and trustworthy output data 124 from input data 120 through a trained function 122. Additional challenges may include comparably small available processing resources or comparably short acceptable processing times for deriving the output data 124 from the input data 120 through the trained function 122, which may make deriving reliable and trustworthy output data 124 from input data 120 through a trained function 122 even more difficult.

To enable the enhanced analysis of input data 120 of a respective device 140 and/or control of the respective device 140, the application software component 106 and/or the processor 102 may, in some examples, be configured to provide input data 120 from the respective device 140.

By way of example, the input data 120 may include an incoming stream of data messages. The input data 120 or the data messages may, for example, include measured, derived, or simulated sensor data (e.g., physical quantities, such as a temperature, a pressure, an electric current, and electric voltage, a distance, a speed or velocity, an acceleration, a flow rate, electromagnetic radiation comprising visible light, or any other physical quantity). In further examples, input data 120 or the data messages may, for example, include images, photos, videos, or other static or moving visual data. Such static or moving “visual” data may further include electromagnetic radiation that is not visible to humans, such as ultraviolet (UV) or infrared (IR) light. In some examples, the input data 120 or the data messages may, for example, include measured, derived, or simulated chemical quantities, such as acidity, a concentration of a given substance in a mixture of substances, and so on. The respective input data 120 may, for example, characterize the respective device 140 or the status in which the respective device 140 is. In some examples, the respective input data 120 may characterize a machining or production step that is carried out or monitored by the respective device 140.

The respective device 140 may, in some examples, be or include a sensor, an actuator, such as an electric motor, a valve or a robot, and inverter supplying an electric motor, a gear box, a programmable logic controller (PLC), a communication gateway, and/or other parts component relating to industrial automation products and industrial automation in general. The respective device 140 may be part of a complex production line or production plant (e.g., a bottle filing machine, conveyor, welding machine, welding robot, or the above-described PCB production line, etc.). In further examples, there may be input data 120 relating to a plurality of such devices 140. Further, by way of example, the respective device 140 may include or be part of an IT system or a manufacturing operation management (MOM) system, a manufacturing execution system (MES), and enterprise resource planning (ERP) system, a supervisory control and data acquisition (SCADA) system, or any combination thereof.

The input data 120 may, by way of example, be stored in the data store 108 of the computing device 118. Further, the respective device 140 may, for example, communicatively be coupled with the computing device 118 (e.g., using a wired or wireless data connection to enable the transmission of the input data 120 from the respective device 140 to the computing device 118).

By way of example, the application software component 106 and/or the processor 102 may further be configured to provide a trained function 122 for processing the input data 120 to generate output data 124, the output data 124 being suitable for analyzing, and/or controlling the respective device 140.

A trained function 122 may, for example, be understood to be or include a machine learning algorithm, a deep learning model, an artificial neural network, or more generally an artificial intelligence-based function. The trained function 122 may generally receive input data 120 that is then processed using the trained function 122 to generate output data 124. In some examples, the trained function 122 may be used for pattern recognition, data mining, image recognition, speech recognition, etc., and may particularly be useful for processing large amounts of data.

The input data 120 may be used to generate output data 124 by applying the trained function 122 to the input data 120. The trained function 122 may, for example, correlate the input data 120 to the output data 124. The output data 124 may be used to analyze or monitor the respective device 140 (e.g., to indicate whether the respective device 140 is working properly or the respective device 140 is monitoring a production step that is executed properly). In some examples, the output data 124 may indicate that the respective device 140 is damaged or that there may be problems with the production step that is monitored by the respective device 140. In other examples, the output data 124 may be used to operate or control the respective device 140 (e.g., by implementing a feedback loop or a control loop using the input data 120, analyzing the input data 120 by applying the trained function 122 and generating the output data 124, and controlling or operating the respective device 140 based on the received input data 120 and the generated output data 124). In some examples, the respective device 140 may be a valve in a process automation plant, where the input data 120 includes data on a flow rate that may then be analyzed with the trained function 122 to generate the output data 124. The output data 124 includes one or more target parameters for the operation of the valve (e.g., a target flow rate or target position of the valve).

The trained function 122 may, by way of example, be stored in the data store 108 of the computing device 118.

In further examples, the application software component 106 and/or the processor 102 may further be configured to determine if the input data 120 is suitable for processing with the trained function 122.

By way of example, the input data 120 may be determined to be suitable for processing with the trained function 122 if the input data 120 has a data format that is compatible with the trained function 122. For example, the trained function 122 may accept only input data 120 of a certain data format with which the input data 120 needs to comply. In some examples, the input data 120 may be determined to be suitable for processing with the trained function 122 if the input data includes feature types for which the trained function 122 may provide meaningful output data 124. For example, the trained function 122 may only provide meaningful output data 124 if the input data 120 includes the feature types “electric current in Ampères” and “luminous flux in lumen” (e.g., occurring during the UV exposure during the PCB production), whereas the trained function 122 may not provide meaningful output data 124 if the input data 120 includes the feature types “electric voltage in Volt” and “luminous flux in lumen”.

Conversely, the input data 120 may be determined to be not suitable for processing with the trained function 122 if the input data 120 has a data format that is incompatible with the trained function 122 or if the feature types of the input data 120 do not comply with the feature types for which the trained function 122 may provide meaningful output data 124.

In some examples, the application software component 106 and/or the processor 102 may further be configured to process the input data 120 with the trained function 122 to generate the output data 124 only if the input data 120 is determined to be suitable for processing with the trained function 122.

Processing only suitable input data 120 with the trained function 122 may considerably increase the reliability and trustworthiness of the generated output data 124. This may, for example, be achieved by avoiding processing unsuitable input data 120 with the trained function 122 since processing unsuitable input data 120 with the trained function may generate unreliable and untrustworthy output data 124.

In some examples, the steps of determining if the input data 120 is suitable for processing with the trained function 122 and of processing only suitable input data 120 with the trained function 122 to generate the output data 124 may be considered as a module or component that may be understood as a “model defender” that may be added to the ML inference pipeline. The model defender may, for example, evaluate input data 120 to the trained function 122 to assess its validity or suitability for the specific trained function 122 at hand. For example, for each input data sample from the respective device 140, a check may be performed based on specific methods or criteria to determine the suitability of the input data and may decide whether the input data 120 should be forwarded to the trained function 122 for generating output data 124 or, alternatively, the trained function 122 should not make a prediction based on this data sample. Further, an alternative data stream path that bypasses the trained function 122 may be opened.

In some examples, the application software component 106 and/or the processor 102 may further be configured to provide at least one suitability criterion 126 for the input data 120. The respective suitability criterion 126 includes an input data image pixel size, an input data image brightness, an input data image luminance, an input data image contrast, an input data image saturation, an input data image size, an input data image color, an input data image hue, an input data image sharpness, an input data image chromaticity, an input data image metadata, or any combination thereof. The application software component 106 and/or the processor 102 may further be configured to determine the input data 120 to be not suitable for processing with the trained function 122 if the input data 120 does not comply with the respective suitability criterion 126 and/or to determine the input data 120 to be suitable for processing with the trained function 122 if the input data 120 complies with the respective suitability criterion 126. In further examples, the respective suitability criterion 126 may further include an input data type, an input data precision value, an input data feature type, an input data feature number, an input data schema type, an input data category, or any combination thereof.

By way of example, the input data type may be a data type, such as an integer, a float, or a string, list, array, etc., or a combination thereof. Further, for the input data type float, the input data precision value may, for example, be characterized by the number of significant digits or the data format single precision, double precision, quadruple precision, etc. In some examples, the number of significant digits of numerical features of new incoming input data 120 may be checked against a derived precision level from historical data.

Further, the input data feature type may characterize one or more of the above-mentioned measured, derived, or simulated physical or chemical quantity of the input data 120 (e.g., in SI units) or the status in which the respective device 140 is. The input data feature number may, by way of example, characterize the number of different features, such as physical or chemical quantities of the input data 120. The input data schema type may, for example, include the number of measurements, the number of meta data fields, a unique identifier field, and optionally the data type within each of the data fields (e.g., float, string, etc.). The input data category may, by way of example, include an expected set, such as an expected component product type from which the input data originates or to which the input data 120 is in relation with. In some examples, the input data feature type, the input data feature number, the input data schema type, and/or the input data category may be derived from the historical data.

The input data image pixel size may be used as respective suitability criterion 126 to check whether an image comprised by the input data (e.g., complies with a given min-max range of the pixel size range that may, in some examples, be derived from the training data). Herein, by way of example, an image pixel may be understood as the smallest addressable element in a raster image, or the smallest addressable element in a dot matrix display device. In most digital display devices, pixels may be the smallest element that may be manipulated through software. In some examples, training data and/or input data image pixel size may not be the same and may be inhomogeneous or inconsistent. Images may then be scaled to have the same pixel size. However, if input data images are way too small or too large, this may lead to misclassifications when applying the trained function 122 for processing the input data 120 to generate output data 124. Then, it may, in some examples, be advisable not to scale and rather, identify this image input data as not suitable so that the suitability criterion is not complied with.

Similar considerations apply to the other, image- or video-related suitability criteria 126, input data image brightness, an input data image luminance, input data image contrast, input data image saturation, input data image size, input data image color, input data image hue, input data image sharpness, and input data image chromaticity. Herein, image hue may, for example, be understood as one of the main properties of a color, defined technically in the CIECAM02 model as “the degree to which a stimulus can be described as similar to or different from stimuli that are described as red, orange, yellow, green, blue, violet,” within certain theories of color vision. Further, image chromaticity may, for example, be understood as an objective specification of the quality of a color regardless of its luminance. Chromaticity consists of two independent parameters, often specified as hue (h) and colorfulness (s), where colorfulness (s) is alternatively referred to as saturation, chroma, intensity, or excitation purity. The image saturation (e.g., of a color) may be determined by a combination of light intensity and how much the light intensity is distributed across the spectrum of different wavelengths. The purest (e.g., most saturated) color may, in some examples, be achieved by using just one wavelength at a high intensity, such as in laser light. If the intensity drops, then as a result, the saturation may drop. Further, the image metadata may, for example, include information on image copyright, white balance, color space, software used to process the image, digital zoom ratio, flash used (e.g., yes/no), rotation, white balance, etc.

By way of example, if the input data 120 is related to an electric current and a related UV exposure during the PCB production, the suitability criterion 126 may include the input data feature types “electric current in Ampères” and “luminous flux in lumen”, the input data feature number may be two (e.g., “electric current in Ampères” and “luminous flux in lumen”), the input data schema type may be ten measurements per second or an average per second, and the input data category may be the related UV lamp.

In further examples, the respective suitability criterion 126 may describe an expected input data profile, where this expected input data profile may be or include one or more of the above-described items, such as an expected minimum, an expected maximum, an expected type, and/or an expected precision of the input data 120, respectively.

The respective suitability criterion 126 may, by way of example, be stored in the data store 108 of the computing device 118.

Using one or more of the described suitability criteria 126 for the input data 120, the input data 120 may be assessed to determine whether the input data 120 is suitable or not suitable for processing with the trained function 122. If there is more than one suitability criterion 126, the input data 120 may, in some examples, only be determined to be suitable if the input data 120 complies with all the suitability criteria 126.

By way of example, the at least one suitability criterion 126 may include a warning criterion and an alarm criterion, where the application software component 106 and/or the processor 102 may further be configured to: determine the input data 120 to be not suitable for processing with the trained function 122 if the input data 120 does not comply with the alarm criterion; and determine the input data 120 to be suitable for processing with the trained function 122 if the input data 120 does not comply with the warning criterion and if the input data 120 complies with the alarm criterion.

The warning criterion and the alarm criterion may, in some examples, be understood as more fine-grained suitability criteria 126. Hereby, the alarm criterion is more stringent and causes the input data 120 to be determined to be not suitable for processing with the trained function 122 if the input data 120 does not comply with the alarm criterion. The warning criterion, however, is less stringent and the input data 120 still may be determined to be suitable for processing with the trained function 122 if the input data does comply with the alarm criterion but does not comply with the warning criterion.

For example, if there is more than one suitability criterion 126, the alarm criterion may be that the input data 120 does not comply with two of these suitability criteria 126, whereas the warning criterion may be that the input data 120 does not comply with one of these suitability criteria 126. In further examples, there may be more important and less important suitability criteria 126. A more important suitability criterion 126 may, for example, immediately negatively affect the quality of a product that is produced with the help of the respective device 140. Further, a more important suitability criterion 126 may, for example, relate to environmental, health, or safety topics related to the respective device 140, such as causing a fire or a potential injury of the production staff. Less important suitability criterion 126 may, for example, relate to long-term effects, such as increased wear of the respective device 140, which may require earlier maintenance, repair, or replacement than normal. In some examples, the alarm criterion may relate to the more important suitability criteria 126, whereas the warning criterion may relate to the less important suitability criteria 126.

In some examples, if the input data 120 does not comply with the respective suitability criterion 126, the application software component 106 and/or the processor 102 may further be configured to: provide at least one curable noncompliance item relating to the respective suitability criterion 126; and amend the input data 120 such that the input data 120 complies with the respective suitability criterion 126, if the input data 120 does not comply with the respective curable noncompliance item relating to the respective suitability criterion 126.

In some examples, a curable noncompliance item may relate to the above-mentioned input data precision value, whereby input data 120 with a higher input data precision value than expected may be amended to a lower input data precision value that corresponds to the expected input data precision value. Such scenarios may occur, for example, if the respective device 140 is replaced with a more performant respective device 140 that is able to provide input data 120 with a higher precision. The explained amendment of the input data 120 to a lower but expected input data precision value may, for example, have the additional benefit that big data volumes may be reduced to only required data volumes that may also speed up the processing of the input data 120 with the trained function 122.

In further examples, if only one or a few piece(s) of input data 120 is/are missing, this may still be acceptable so that the above-mentioned input data feature number may also constitute a curable noncompliance item (e.g., if the actual the expected input data feature number differ by one or only a few). In such cases, the input data 120 may be completed by substituting the missing piece(s) of input data 120 with a default value (e.g., a recent average of the now missing feature or the average of the features of the 10 or 100 preceding pieces of input data 120).

In some examples, the input data may include more features than expected (e.g., if the respective device 140 is replaced with a more performant respective device 140 that is able to provide at least one additional feature in the input data 120). Since the trained function 122 may, in some examples, not use the respective additional feature of the input data 120 to generate meaningful output 124, amending the input data 120 by omitting the respective additional feature may keep the analysis of the input data 120 or the control of the respective device 140 operational and reliable.

In further examples, the input data 120 may accidentally include the correct information, but in a wrong data format (e.g., as a string instead of a float format). Accordingly, the above-mentioned input data type may also constitute a curable noncompliance item. Amending the input data 120 by changing the input data type to the expected and accepted input data type may therefore, in some examples, keep the analysis of the input data 120 or the control of the respective device 140 operational and reliable.

For the respective curable noncompliance item, the required amendments may be determined beforehand and may be provided to amend the input data 120 such that the input data 120 complies with the respective suitability criterion 126.

In further examples, if the input data 120 does not comply with the respective suitability criterion 126, the application software component 106 and/or the processor 102 may further be configured to generate a respective message 128 indicating that the input data 120 does not comply with the respective suitability criterion 126. The respective message 128 includes information on the respective suitability criterion 126 with which the input data 120 does not comply with. The application software component 106 and/or the processor 102 may further be configured to provide the generated respective message 128 to a user or an operator of the respective device 140.

Especially since the respective message 128 may also include information on the respective suitability criterion 126 with which the input data 120 does not comply, for example, not only a data scientist, but also a test engineer or an operator of the respective device 140 or a plant including the respective device 140, may be able to understand the underlying problem leading to the noncompliance of the respective suitability criterion 126. In some examples, the respective message 128 including the respective suitability criterion 126 with which the input data 120 does not comply may include further information about the kind of observation that has been made or been detected in cases of bad input data 120. Hence, the mentioned further information may, for example, facilitate remediating persisting problems in the input data 120 and reduce the investigation time.

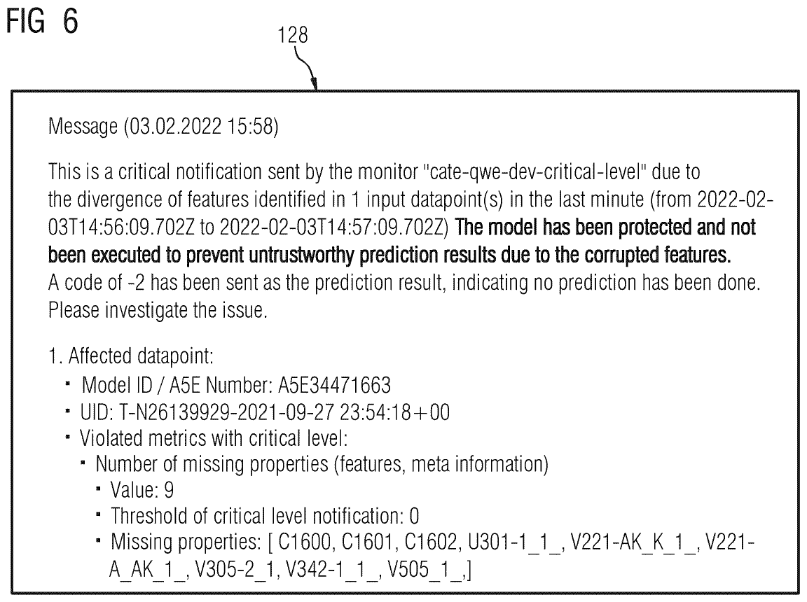

An example message 128 in the context of facilitated analysis of input data of a respective device 140 and/or control of the respective device 140 in a product system is illustrated in FIG. 6. Herein, the example message 128 includes the statement “The model has been protected and not been executed to prevent untrustworthy prediction results due to the corrupted features,” which indicates that the input data 120 does not comply with at least one suitability criterion 126 and that the input data 120 is not provided to the trained function 122 to generate output data 124. The example message 128 of FIG. 6 further includes the statements:
“Violated metrics with critical level:
Number of missing properties (features, meta information)
Value: 9
Threshold of critical level notification: 0
Missing properties: ( . . . ) [C1600, C1601, C1602, U301-1_1_, V221-AK_K_1_, V221-A_AK_1_, V305-2_1, V342-1_1_, V505_1_,]”
   which may, by way of example, indicate that there may be a value of the above-mentioned, expected input data feature number. According to the example message 128, the number of acceptable missing input data features is 0, whereas the actual number of acceptable missing input data feature is 9 (e.g., the nine features corresponding to the quantities in squared brackets), which causes the noncompliance of the input data 120.

From this example message 128, it may become evident that the respective message 128 may, in some examples, be fairly easy to understand also for non-experts in the field of data science, such as ordinary test engineers or operators of the respective device 140 or a plant including the respective device 140. This facilitated understandability and interpretability of the respective message 128 may, for example, be enabled by enriching the respective message 128 with the information on the respective suitability criterion 126 with which the input data 120 does not comply. In some examples, the respective message 128 may include information on both the respective suitability criterion 126 and how or why the input data 120 does not comply with the respective suitability criterion 126. In further examples, the respective message 128 may include the input data 120 that does not comply with the respective suitability criterion 126.

The provision of the generated respective message 128 to the user or the operator of the respective device 140 may, by way of example, be achieved by displaying the generated message 128 to the user or the operator via the above-mentioned display device 112. In some examples, the generated message 128 may be displayed to the user or the operator on his or her smartphone, laptop, tablet, or other mobile device or personal computer. In further examples, the generated respective message 128 may be provided to the user or the operator of the respective device 140 as a voice message.

By way of example, the respective message 128 may be stored in the data store 108 of the computing device 118. Further, in some examples, if there are two or more suitability criteria 126 with which the input data 120 does not comply with (e.g., a given data point of the input data 120 or the input data 120 of a given, such as short, time interval, there may only be one comprehensive message 128 that may include the indication that the input data 120 does not comply with these two or more suitability criteria 126 and may further include information on these two or more suitability criteria 126 with which the input data 120 does not comply).

In some examples, the respective message 128 may be provided to an IT system, a MOM system, a MES, an ERP system, or a SCADA system that is communicatively connected with the computing device 118 and that, in some examples, may analyze, monitor, operate, control, or manage the respective device 140.

In some examples, the application software component 106 and/or the processor 102 may further be configured to: provide an acceptable data drift 130 with respect to the input data 120; determine a respective updated suitability criterion 126′ taking the acceptable drift 130 into account; and replace the respective suitability criterion 126 with the respective updated suitability criterion 126′.

A data drift 130 may, for example, be understood as a change of statistical moments of a distribution over time compared to training or historical data. In some examples, the respective device 140 may be subject to wear or aging processes that may be known or expected beforehand, and that may influence the input data 120 that may be related to the respective device 140. In such cases, wear or aging may lead to an expected and acceptable data drift 130 of the input data 120 over time, whereby this acceptable data drift may be taken into account by updating the respective suitability criterion 126 to obtain respective updated suitability criterion 126′. By way of example, the input data 120 or a physical or chemical quantity comprised by the input data 120 may undergo a certain offset after a certain period of time, whereby this data drift 130 may be a linear or more complex function of time. Further, the data drift 130 may not directly depend on the period of time, but rather on a number of times of use of the respective device 140 or of an intensity of a load or stress exerted on the respective device 140.

The mentioned wear and ageing effects may be used to determine the acceptable data drift 130 that may then be used to determine the respective updated suitability criterion 126′. The respective updated suitability criterion 126′ may then replace the respective suitability criterion 126 against which the input data 120 may be checked and compared.

By way of example, the acceptable data drift 130 and/or the respective updated suitability criterion 126′ may be stored in the data store 108 of the computing device 118.

In further examples, if the input data 120 is determined to be not suitable for processing with the trained function 122, the application software component 106 and/or the processor 102 may further be configured to provide fallback output data 124′ being suitable for analyzing and/or controlling the respective device 140.

In some examples, the respective input data 120 may characterize a machining or production step that is carried out or monitored by the respective device 140 and during which a product which is machined, handled, or produced. If the input data 120 is determined not to be suitable for processing with the trained function 122, the fallback output data 124′ may indicate that the quality of this product may not sufficient, that this product may need to be sorted out and/or that further tests to check the product quality may be required. Further, in some examples, the fallback output data 124′ may map the input data 120 to some output that is uncritical (e.g., for the production process in which the respective device 140 is involved). In the case of binary predictions, the most conservative fallback may, for example, be a mapping to the “real error” class of the trained function 122, resulting, for example, in the above PCB production line, in a manual check of the PCB. Hence, the fallback output data 124′ may, in some examples, avoid faulty products in further processing steps.

In some examples, the respective input data 120 may characterize the respective device 140 or a production line including the respective device 140. If the input data 120 is determined not to be suitable for processing with the trained function 122, the fallback output data 124′ may indicate that the respective device 140 or the mentioned production line may have a malfunction, may need a maintenance or repair, or may need to be shut down.

In further examples, if the input data 120 is determined not to be suitable for processing with the trained function 122, the fallback output data 124′ may trigger or be used to trigger a switch of the respective device 140 or a production line including the respective device 140 from an operating mode into a safe mode in a functional safety context. Such scenarios may, for example, be applied if the input data 120 does not comply with the above-mentioned alarm criterion or if environmental, health, or safety topics related to the respective device 140 are concerned, such as causing a fire or a potential injury of the production staff.

By way of example, the fallback output data 124′ may be determined beforehand and/or be stored in the data store 108 of the computing device 118. In some examples, the fallback output data 124′ may be provided to an IT system, a MOM system, a MES, an ERP system, or a SCADA system that is communicatively connected with the computing device 118 and that, in some examples, may analyze, monitor, operate, control, or manage the respective device 140.

In some examples, the application software component 106 and/or the processor 102 may further be configured to: assign a first flag 132 to the input data 120 if the input data 120 is determined to be suitable for processing with the trained function 122; and/or assign a second flag 134 to the input data 120 if the input data 120 is determined to be not suitable for processing with the trained function 122.

By way of example, the first flag 132 and the second flag 134 may be understood as a data quality flag that may be assigned to the respective input data 120. The first flag 132 and the second flag 134 may, for example, simply indicate that the input data 120 may be “ok” or “not okay” (e.g., suitable or not suitable for processing with the trained function 122, respectively). The second flag 134 indicating not suitable input data 120 may, for example, be used to open an alternative data stream path to bypass the trained function 122. In this case, input data 120 and the second flag 134 may be transmitted (e.g., being comprised by the above-mentioned respective message 128) through this channel to avoid predictions of the trained function 122 on bad data. The second flag 134 and the respective message 128 may, for example, be provided to a user or an operator of the respective device 140.

Further, the first flag 132 and the second flag 134 may, in some examples, facilitate preserving the information if a particular piece of input data 120 has been determined to be suitable or not suitable for processing with the trained function 122. This preserved information may, for example, facilitate a later evaluation of the quality or performance of the respective device 140 or a machining or production step that is carried out or monitored by the respective device 140. The production line includes the respective device 140. In this way, this preserved information may, for example, facilitate remediation efforts, such as a retraining of the trained function 122 or identifying and executing a potentially required maintenance, repair, or replacement of the respective device 140.

By way of example, the first flag 132 and/or the second flag 134 may be determined beforehand and/or be stored in the data store 108 of the computing device 118. In some examples, the first flag 132 and/or the second flag 134 may be provided to an IT system, a MOM system, a MES, an ERP system, or a SCADA system that is communicatively connected with the computing device 118 and that, in some examples, may analyze, monitor, operate, control, or manage the respective device 140.

In some embodiments, the determination if the input data 120 is suitable for processing with the trained function 122 and the processing of the input data 120 with the trained function 122 may be performed by a computation device 118. In further embodiments, the computation device 118 may be arranged in the same communication network as the respective device 140. In another embodiment, the computation device 118 may be arranged within a radius of 5 m of the respective device 140. In a further example, the computation device 118 may communicatively be connected with the respective device 140 with a latency of less than 10 ms. One or more of these aspects in the context of the computation device 118 may be combined.

In some examples, such a computing device 118 may be understood as an edge device that may be arranged in an industrial environment in the process level, the field level, or the control level of an industrial production facility. Further, the respective device 140 may, for example, also be such an edge device. In further examples, the computation device 118 may have similar computing and memory resources than a state-of-the-art smartphone (e.g., in the year 2022, 4 GB or 8 GB RAM, up to a 4- or 6 -core CPU with 2 to 3.5 GHZ, and up to 512 GB of memory), whereby these state-of-the-art computing and memory resources are expected to become larger over time. In yet further examples, the computation device 118 may have similar computing and memory resources as a state-of-the-art, but low-cost smartphone (e.g., resources costing or being of the order of 20% to 50% of the above-mentioned RAM, CPU, and memory resources). Hereby, the computing device 118 may, for example, be embodied as an industrial PC.

In some examples, the computation device 118 and the respective device 140 may be arranged locally or network-wise close to each other (e.g., to allow for communication with each other with a latency of less than 10 ms), or the computation device 118 and the respective device 140 may be arranged within a radius of up to 2 m. The computation device 118 and the respective device 140 may, for example, be arranged in the same communication network as the respective device 140, which may, for example, provide that there is no communication gateway arranged between the computation device 118 and the respective device 140.

An accordingly arranged computation device 118 and respective device 140 may facilitate and sometimes enable quick and reliable execution of the determination if the input data 120 suitable for processing with the trained function 122 and of the processing of the input data 120 with the trained function 122. Further, this quick and reliable execution of the two tasks may, for example, enable inspection in manufacturing (e.g., conducting inspection during the production process), which helps to control the quality of products by helping to fix the sources of defects immediately after the defects are detected, and it is useful for any factory that wants to improve productivity, reduce defect rates, and reduce re-work and waste. In some examples, this quick and reliable execution of the two tasks may, for example, enable closed-loop manufacturing, which is a closed-loop process of manufacturing and measuring or checking in the manufacturing machine (e.g., the respective device 140 or the production plant including the respective device 140). Hereby, closed-loop manufacturing may reduce costs and improve the quality and accuracy of the produced parts.

In some examples, the application software component 106 and/or the processor 102 may further be configured to analyze and/or control the respective device 140 using the output data 124 and optionally the fallback output data 124′.

In some examples, the application software component 106 and/or the processor 102 may further be configured to: analyze and/or control a manufacturing process of a product using the respective device 140; and determine if the product quality is sufficient using the output data 124 and optionally the fallback output data 124′.

Herein, the manufacturing process of the product may, for example, be a discrete manufacturing process of distinct product items. In some examples, the manufacturing process of the product may be a continuous or process manufacturing process that is associated with formulas and manufacturing recipes. Hereby, process manufacturing may sometimes also be referred to as a “process industry,” which may be defined as an industry, such as the chemical or petrochemical industry, that is concerned with the processing of bulk resources into other products.

By way of example, the respective device 140 may be any one of a production machine, an automation device, a sensor, a production monitoring device, a vehicle or any combination thereof.

The respective device 140 may, in some examples, be or include a sensor, an actuator, such as an electric motor, a valve or a robot, an inverter supplying an electric motor, a gear box, a programmable logic controller (PLC), a communication gateway, and/or other parts component relating to industrial automation products and industrial automation in general. The respective device 140 may be (part of) a complex production line or production plant (e.g., a bottle filing machine, conveyor, welding machine, welding robot, etc.). Further, by way of example, the respective device may be or include a manufacturing operation management (MOM) system, a manufacturing execution system (MES), an enterprise resource planning (ERP) system, a supervisory control and data acquisition (SCADA) system, or any combination thereof.

In an industrial embodiment, the suggested method and system may be realized in the context of an industrial production facility (e.g., for producing parts of product devices, such as printed circuit boards, semiconductors, electronic components, mechanical components, machines, robots, devices, vehicles or parts of the vehicles, such as cars, motorcycles, airplanes, ships, or the like) or an energy generation or distribution facility (e.g., power plant in general, transformers, switch gears, the like). By way of example, the suggested method and system may be applied to certain manufacturing steps during the production of the product device, such as milling, grinding, welding, forming, painting, cutting, etc. (e.g., monitoring or even controlling the welding process, such as during the production of cars). For example, the suggested method and system may be applied to one or a number of plants performing the same task at different locations, whereby the input data 120 may originate from one or a number of these plants that may allow for monitoring, operating, and/or the controlling of the respective device 140 or plant(s). In further examples, the suggested method and system may be realized in the context of assisted or autonomous driving (e.g., of vehicle, such as cars, motorcycles, airplanes, ships, or the like), where the respective device 140 may be or be comprised in the vehicle, which may be analyzed and/or controlled using the suggested method.

The suggested method and system may, in some examples, have the following advantages in the context of a machine learning pipeline execution (e.g., on an edge IPCs close to the production line): Without the suggested approach, the trained function 122 or the ML model may not be able to execute for bad input data 120. This may cause an exception in the embedding software, which may crash the entire ML application. This may delay the production process, which relies on feedback by the trained function 122 in case of detected failures by the test equipment or the respective device. Using the suggested method and system, these drawbacks may reliably be avoided.

Further, the suggested method and system may help to avoid ML model predictions via the trained model 122 for out-of-domain input data samples. The trained function 122 may be trained on a historical data set with boundaries on numerical data. Generalization of ML model predictions to values outside of the known boundaries may not be determined during model training. Further, labelled data for out-of-boundary data may not available. In the worst case, values outside of the known boundaries may lead to “false negative” predictions with a high ML model confidence. This may directly jeopardize the quality of the produced products by introducing additional quality slip into the production. Using the suggested method and system, these drawbacks may also reliably be avoided.

Further, the suggested method and system may help to reduce the required time to fix problems. Transmitting the above-mentioned messages 128 (e.g., the result of the above-mentioned model defender evaluations) directly to the responsible user, test engineer, or data scientist may reduce the time to fix occurring problems. By pointing directly towards the type of violation in the input data 120, an underlying upstream problem may be fixed more efficiently. Without the suggested method and system, potentially laborious and time-consuming data tracing and bug investigations may be required to find the cause for missing model predictions. This may, in some examples, be achieved thanks to interpretable output. In this way, not only a data scientist, but also a regular user, test engineer, or operator may understand the underlying problem. For example, an incoming datapoint with a missing unique identifier and an outlier feature value would send the following messages (e.g., among others) to the consumer, which may comparably be easy to understand and interpret:
“CRITICAL: Feature ‘meta’ violated ‘required’.‘uid’ is a required property”,
“NOTICE: Feature ‘C721’ violated ‘lower_outlier_threshold’.1.089 is lower than the lower outlier threshold 1.103. It is an outlier.”

Further, by way of example, default alerting and defending thresholds (e.g., for the above-mentioned warning criterion and alarm criterion) may be used, which may be based on validation errors on historical data that may be used to derive default alerting and defending thresholds for the individual validation types or suitability criterion 128. Hereby, typically, the warning threshold may be less strict than the alarm threshold. Hence, if the number of violations break the warning criterion, but not the alarm threshold, the user already receives warning messages that may help him to prevent a potential interference of the above-mentioned model defender at all.

With reference to FIG. 2, a flow diagram of another methodology of analyzing input data 120 of a respective device 140 is illustrated as already explained above.

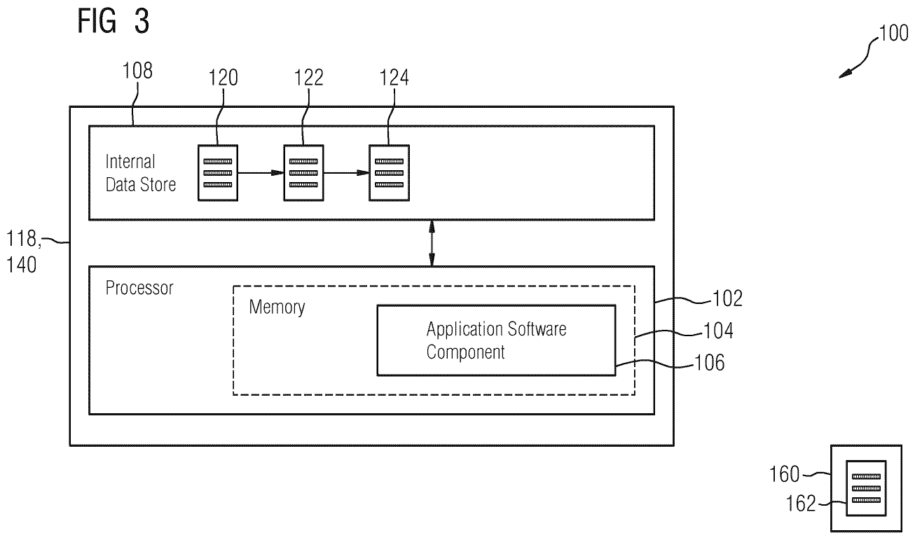

With reference to FIG. 3, a functional block diagram of another example data processing system 100 that facilitates analyzing input data 120 of a respective device 140 and/or controlling the respective device 140 is illustrated.

As illustrated in FIG. 3, the computation device 118 may be the same as the respective device 140. Accordingly, the input data 120 originates from the same device that, in some examples, also performs the steps of determining if the input data 120 is suitable for processing with the trained function 122 and processing the input data 120 with the trained function 122 to generate the output data 124 only if the input data 120 is determined to be suitable for the processing with the trained function 122.

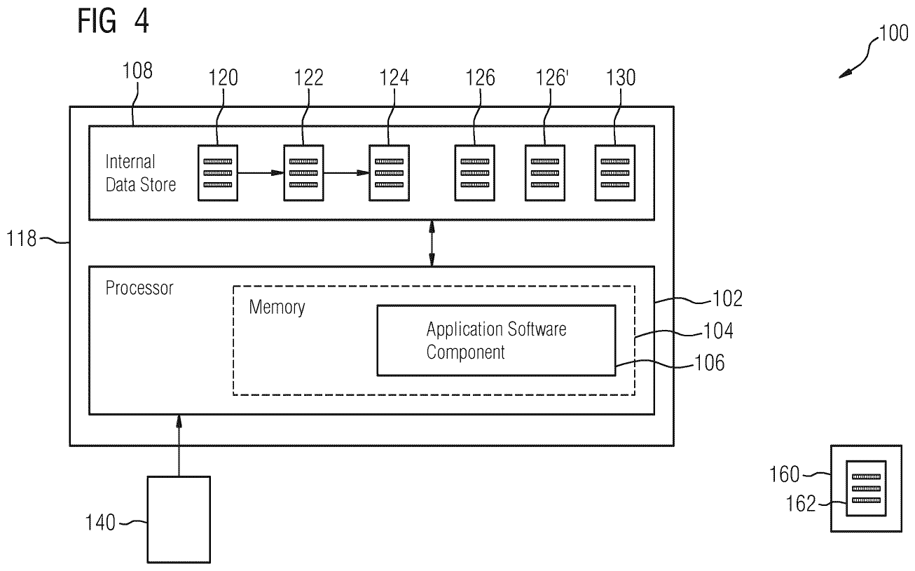

With reference to FIG. 4, a functional block diagram of a further example data processing system 100 that facilitates analyzing input data 120 of a respective device 140 and/or controlling the respective device 140 is illustrated.

As illustrated in FIG. 4, a suitability criterion 126 for the input data 120 may be provided and stored in the data store 108, where the suitability criterion 126 may include an input data type, an input data precision value, an input data feature type, an input data feature number, an input data schema type, an input data category, an input data image pixel size, an input data image brightness, an input data image luminance, an input data image contrast, an input data image saturation, an input data image size, an input data image color, an input data image hue, an input data image sharpness, an input data image chromaticity, an input data image metadata, or any combination thereof. The input data 120 may be determined to be suitable or to be not suitable for processing with the trained function 122 if the input data 120 complies or does not comply with the respective suitability criterion 126, respectively.

Further, an acceptable data drift 130 with respect to the input data 120 may be provided and stored in the data store 108, whereby an updated suitability criterion 126′ may be determined taking the acceptable drift 130 into account. The suitability criterion 126 may then be replaced with the updated suitability criterion 126′, which may also be stored in the data store 108.

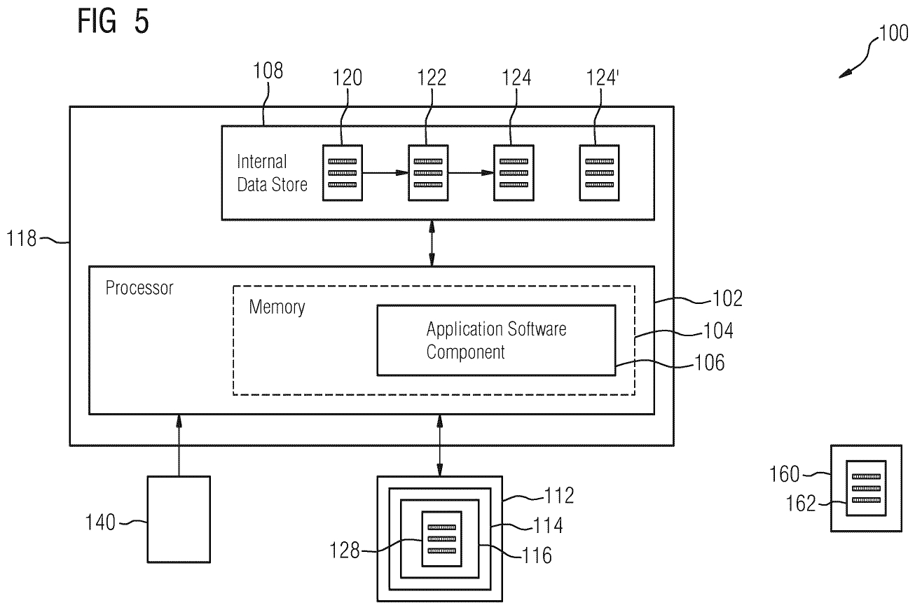

With reference to FIG. 5, a functional block diagram of yet another example data processing system 100 that facilitates analyzing input data 120 of a respective device 140 and/or controlling the respective device 140 is illustrated.

As illustrated in FIG. 5, a message 128 may be generated and displayed via the GUI 114 that is displayed on the display device 112. The GUI 114 may include an analysis or control UI 116 in which the message 128 may be displayed. An example message 128 is illustrated in FIG. 6 and explained above.

If the input data 120 is determined to be not suitable for processing with the trained function 122, fallback output data 124′ may be provided and stored in the data store 108, whereby the fallback output data 124′ may be suitable for analyzing and/or controlling the respective device 140.

With reference to FIG. 6, an example message in the context of facilitated analysis of input data of a respective device and/or control of the respective device is illustrated as already explained above.

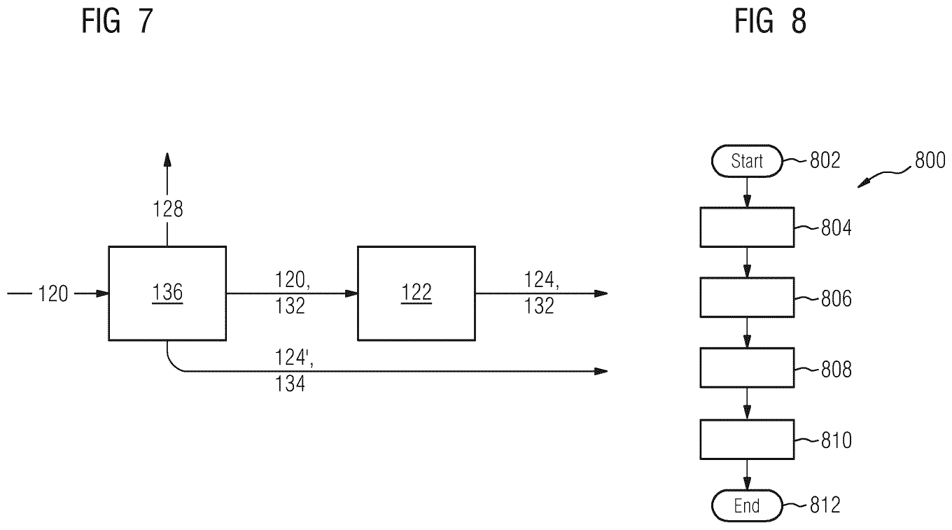

Referring now to FIG. 7, a flow diagram of an example methodology that facilitates analyzing input data 120 of a respective device 140 and/or controlling the respective device 140 is illustrated.

As illustrated in FIG. 7, input data 120 may be provided and may be processed to determine if the input data 120 is suitable for processing with the trained function 122. This processing and determination step may be done by a model defender module 136 that may only admit suitable input data 120 to the trained function 122.

If the input data 120 does not comply with the suitability criterion 126, a message 128 may be generated and, for example, be provided to a user or an operator of the respective device 140 (e.g., by providing the message 128 to an IT system, a MOM system, a MES, an ERP system, or a SCADA system that is communicatively connected with the computing device 118 and that, in some examples, may analyze, monitor, operate, control, or manage the respective device 140). Hereby, the message 128 may indicate that the input data 120 does not comply with the respective suitability criterion 126, whereby the respective message 128 may include information on the respective suitability criterion 126 with which the input data 120 does not comply.

Only if the input data 120 is determined to be suitable for processing with the trained function 122 and, for example, complies with the suitability criterion 126, the input data 120 is processed with the trained function 122 to generate output data 124.

Further, a first flag 132 or a second flag 134 may be assigned to the input data 120 if the input data 120 is determined to be suitable or to be not suitable for processing with the trained function 122, respectively. The first flag 132 and the second flag 134 may, for example, be provided to an IT system, a MOM system, a MES, an ERP system, or a SCADA system that is communicatively connected with the computing device 118 and that, in some examples, may analyze, monitor, operate, control, or manage the respective device 140.

If the input data 120 is determined to be not suitable for processing with the trained function 122, fallback output data 124′ that may be suitable for analyzing and/or controlling the respective device 140 may be provided. The input data 120 of respective device 140 may then be analyzed, and/or the respective device 140 may then be controlled using the output data 124 and optionally the fallback output data 124′. Further, a manufacturing process of a product using the respective device 140 may be analyzed and/or controlled, whereby it may be determined if the product quality is sufficient using the output data 124 and optionally the fallback output data 124′.

Referring now to FIG. 8, a flow diagram of another example methodology that facilitates analyzing input data of a respective device and/or controlling the respective device is illustrated. The methodology 800 may start at 802 and may include a number of acts carried out through operation of at least one processor.

These acts may include: an act 804 of providing input data from the respective device; an act 806 of providing a trained function for processing the input data to generate output data, the output data being suitable for analyzing and/or controlling the respective device; an act 808 of determining if the input data is suitable for processing with the trained function; and an act 810 of processing the input data with the trained function to generate the output data only if the input data is determined to be suitable for processing with the trained function. At 812, the methodology may end.

The methodology 800 may include other acts and features discussed previously with respect to the computer-implemented method of analyzing input data of a respective device and/or controlling the respective device.

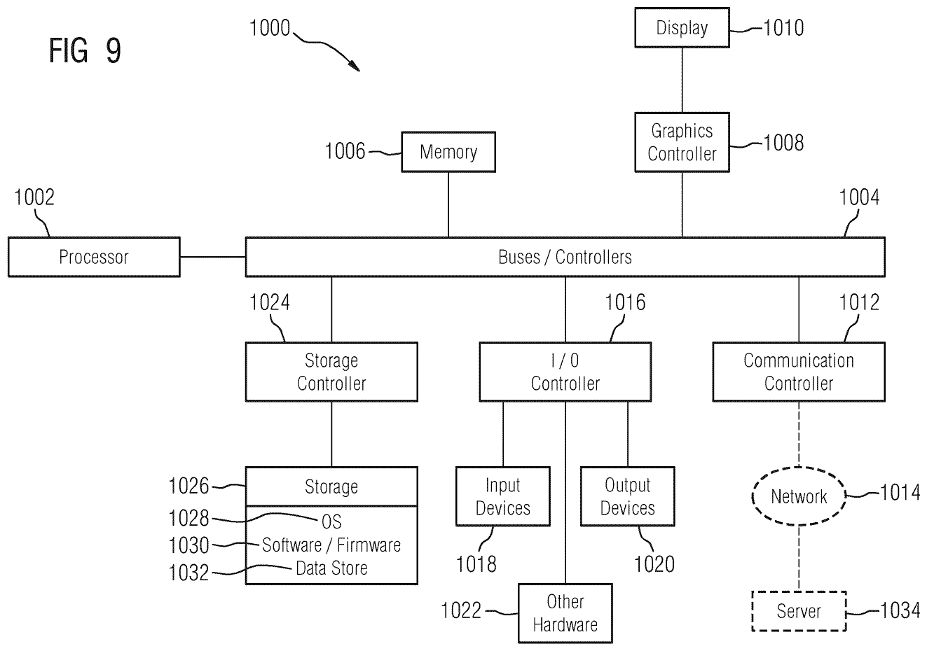

FIG. 9 illustrates a block diagram of a data processing system 1000 (also referred to as a computer system) in which an embodiment may be implemented, for example, as a portion of a product system, and/or another system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge).

One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. In some embodiments, one or more controllers (e.g., graphics, south bridge) may be integrated with the CPU (e.g., on the same chip or die). Examples of CPU architectures include IA-32, x86-64, and ARM processor architectures.

Other peripherals connected to one or more buses may include communication controllers 1012 (e.g., Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (e.g., connected to speakers and/or microphones). Various peripherals may be connected to the I/O controller(s) (e.g., via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers), or any other type of device that is operative to provide inputs to or receive outputs from the data processing system. Many devices referred to as input devices or output devices may both provide inputs and receive outputs of communications with the data processing system. For example, the processor 1002 may be integrated into a housing (e.g., a tablet) that includes a touch screen that serves as both an input and display device. Further, some input devices (e.g., a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which may be any suitable non-transitory machine usable or machine-readable storage medium. Examples include nonvolatile devices, volatile devices, read only devices, writable devices, ROMs, EPROMS, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (e.g., that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data that is retrievable by a processor.

The communication controllers 1012 may be connected to the network 1014 (e.g., not a part of data processing system 1000) that may be any public or private data processing system network or combination of networks, as known to those of skill in the art, including the Internet. Data processing system 1000 may communicate over the network 1014 with one or more other data processing systems such as a server 1034 (e.g., also not part of the data processing system 1000). However, an alternative data processing system may correspond to a plurality of data processing systems implemented as part of a distributed system in which processors associated with a number of data processing systems may be in communication via one or more network connections and may collectively perform tasks described as being performed by a single data processing system. Thus, it is to be understood that when referring to a data processing system, such a system may be implemented across a number of data processing systems organized in a distributed system in communication with each other via a network.

Further, the term “controller” may be any device, system, or part thereof that controls at least one operation, whether such a device is implemented in hardware, firmware, software, or some combination of at least two of the same. The functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be comprised in a client device that communicates with the server (e.g., and/or a virtual machine executing on the server) through a wired or wireless network (e.g., including the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein, a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, the words or phrases used herein should be construed broadly, unless expressly limited in some examples. For example, the terms “comprise” and “comprise,” as well as derivatives thereof, may provide inclusion without limitation. The singular forms “a”, “an”, and “the” are intended to include the plural forms as well, unless the context clearly indicates otherwise. Further, the term “and/or” as used herein refers to and encompasses any and all possible combinations of one or more of the associated listed items. The term “or” is inclusive, providing and/or, unless the context clearly indicates otherwise. The phrases “associated with” and “associated therewith,” as well as derivatives thereof, may provide to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first,” “second,” “third,” and so forth may be used herein to describe various elements, functions, or acts, these elements, functions, or acts should not be limited by these terms. Rather, these numeral adjectives are used to distinguish different elements, functions, or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may provide the processor is operatively configured to or operably configured to carry out the functions or processes via software, firmware, and/or wired circuits. For example, a processor that is configured to carry out a function/process may correspond to a processor that is executing the software/firmware that is programmed to cause the processor to carry out the function/process and/or may correspond to a processor that has the software/firmware in a memory or storage device that is available to be executed by the processor to carry out the function/process. A processor that is “configured to” carry out one or more functions or processes, may also correspond to a processor circuit particularly fabricated or “wired” to carry out the functions or processes (e.g., an ASIC or FPGA design). Further, the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may provide that an element is relatively near to but not in contact with a further element; or that the element is in contact with the further portion, unless the context clearly indicates otherwise.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method of analyzing input data of a respective device, controlling the respective device, or analyzing the input data of the respective device and controlling the respective device, the computer-implemented method comprising:
providing input data from the respective device;
providing a trained function for processing the input data to generate output data, the output data being suitable for analyzing, controlling, or analyzing and controlling the respective device;
determining if the input data is suitable for processing with the trained function;
processing the input data with the trained function, such that the output data is generated only if the input data is determined to be suitable for processing with the trained function;
providing at least one suitability criterion for the input data, the at least one suitability criterion comprising an input data image pixel size, an input data image brightness, an input data image luminance, an input data image contrast, an input data image saturation, an input data image size, an input data image color, an input data image hue, an input data image sharpness, an input data image chromaticity, an input data image metadata, or any combination thereof; and
determining the input data to be suitable for processing with the trained function when the input data complies with a first suitability criterion of the at least one suitability criterion;
determining the input data to be not suitable for processing with the trained function when the input data does not comply with the first suitability criterion or a second suitability criterion of the at least one suitability criterion; or
a combination thereof.

2. The computer-implemented method of claim 1, wherein the at least one suitability criterion comprises a warning criterion and an alarm criterion,
wherein the computer-implemented method further comprises:
determining the input data to be not suitable for processing with the trained function when the input data does not comply with the alarm criterion; and
determining the input data to be suitable for processing with the trained function when the input data does not comply with the warning criterion and when the input data complies with the alarm criterion.

3. The computer-implemented method claim 1, further comprising:
when the input data does not comply with the respective suitability criterion:
providing at least one curable noncompliance item relating to the at least one suitability criterion; and
amending the input data such that the input data complies with the at least one suitability criterion when the input data does not comply with the at least one curable noncompliance item relating to the at least one suitability criterion.

4. The computer-implemented method of claim 1, further comprising:
when the input data does not comply with the at least one suitability criterion:
generating a respective message indicating that the input data does not comply with the at least one suitability criterion, the respective message comprising information on a respective suitability criterion of the at least one suitability criterion with which the input data does not comply; and
providing the generated respective message to a user or an operator of the respective device

5. The computer-implemented method of claim 1, further comprising:
providing an acceptable data drift with respect to the input data;
determining at least one updated suitability criterion taking the acceptable drift into account; and
replacing the at least one suitability criterion with the at least one updated suitability criterion.

6. The computer-implemented method of claim 1, further comprising:
when the input data is determined to be not suitable for processing with the trained function:
providing fallback output data that is suitable for analyzing, controlling, or analyzing and controlling the respective device.

7. The computer-implemented method of claim 1, further comprising:
assigning a first flag to the input data when the input data is determined to be suitable for processing with the trained function;
assigning a second flag to the input data when the input data is determined to be not suitable for processing with the trained function; or
a combination thereof.

8. The computer-implemented method of claim 1, wherein the determining of if the input data is suitable for processing with the trained function and the processing of the input data with the trained function is performed by a computation device, and
wherein the computation device is arranged in a same communication network as the respective device, the computation device is arranged within a radius of 5 m of the respective device, the computation device is communicatively connected with the respective device with a latency of less than 10 ms, or any combination thereof.

9. The computer-implemented method of claim 1, further comprising:
analyzing, controlling, or analyzing and controlling the respective device using the output data.

10. The computer-implemented method of claim 6, further comprising:
analyzing, controlling, or analyzing and controlling a manufacturing process of a product using the respective device; and
determining if the product quality is sufficient using the output data and.

11. The computer-implemented method of claim 1, wherein the respective device is a production machine, an automation device, a sensor, a production monitoring device, a vehicle, or any combination thereof.

12. A computation device configured to analyze input data of a respective device, control the respective device, or analyze the input data of the respective device and control the respective device, the computation device comprising:
a processor configured to:
provide input data from the respective device;
provide a trained function for processing the input data to generate output data, the output data being suitable for analyzing, controlling, or analyzing and controlling the respective device;
determine if the input data is suitable for processing with the trained function;
process the input data with the trained function, such that the output data is generated only if the input data is determined to be suitable for processing with the trained function;
provide at least one suitability criterion for the input data, the at least one suitability criterion comprising an input data type, an input data precision value, an input data feature type, an input data feature number, an input data schema type, an input data category, an input data image pixel size, an input data image brightness, an input data image luminance, an input data image contrast, an input data image saturation, an input data image size, an input data image color, an input data image hue, an input data image sharpness, an input data image chromaticity, an input data image metadata, or any combination thereof; and
determine the input data to be suitable for processing with the trained function when the input data complies with a first suitability criterion of the at least one suitability criterion;
determine the input data to be not suitable for processing with the trained function when the input data does not comply with the first suitability criterion or a second suitability criterion of the at least one suitability criterion; or
a combination thereof.

13. (canceled)

14. A non-transitory computer-readable storage medium that stores instructions executable by one or more processors to analyze input data of a respective device, control the respective device, or analyze the input data of the respective device and control the respective device, the instructions comprising:
providing input data from the respective device;
providing a trained function for processing the input data to generate output data. the output data being suitable for analyzing, controlling, or analyzing and controlling the respective device;
determining if the input data is suitable for processing with the trained function;
processing the input data with the trained function, such that the output data is generated only if the input data is determined to be suitable for processing with the trained function;
providing at least one suitability criterion for the input data, the at least one suitability criterion comprising an input data type, an input data precision value, an input data feature type, an input data feature number, an input data schema type, an input data category, an input data image pixel size, an input data image brightness, an input data image luminance, an input data image contrast, an input data image saturation, an input data image size, an input data image color, an input data image hue, an input data image sharpness, an input data image chromaticity, an input data image metadata, or any combination thereof; and
determining the input data to be suitable for processing with the trained function when the input data complies with a first suitability criterion of the at least one suitability criterion;
determining the input data to be not suitable for processing with the trained function when the input data does not comply with the first suitability criterion or a second suitability criterion of the at least one suitability criterion; or
a combination thereof.

15. The computer-implemented method of claim 6, further comprising:
analyzing, controlling, or analyzing and controlling the respective device using the output data and the fallback output data.

16. The computer-implemented method of claim 6, further comprising:
analyzing, controlling, or analyzing and controlling a manufacturing process of a product using the respective device; and
determining if the product quality is sufficient using the output data and the fallback output data.

17. The computer-implemented method of claim 1, wherein the at least one suitability criterion further comprises an input data type, an input data precision value, an input data feature type, an input data feature number, an input data schema type, an input data category, or any combination thereof.
